(19) United States
(12) Patent Application Publication
(10) Pub. No.: US 2026/0189302 A1
(43) Pub. Date: Jul. 2, 2026

(54) OFDM-NOMA OPTICAL TRANSMISSION METHOD AND DEVICE LEVERAGING CHROMATIC DISPERSION

(71) Applicant: UIF (University Industry Foundation), Yonsei University, Seoul (KR)

(72) Inventors: Sang-Kook HAN, Seoul (KR); Joungmoon LEE, Seoul (KR); Jinwoo PARK, Seoul (KR); Young-Jin HYUN, Seoul (KR); Hyemin PARK, Seoul (KR)

(21) Appl. No.: 19/432,840

(22) Filed: Dec. 24, 2025

(30) Foreign Application Priority Data
Dec. 30, 2024 (KR) 10-2024-0200826

(51) Int. Cl. H04B 10/50; H04B 10/25; H04B 10/54; H04B 10/548

(52) U.S. Cl. CPC H04B 10/505; H04B 10/25; H04B 10/54; H04B 10/548

(57) ABSTRACT

An optical transmission method and device which enable an optical reception device to easily detect an optical signal transmitted to itself from optical reception signals transmitted in an overlapping manner using a single photodetector, includes: receiving data to be transmitted to first and second optical reception devices to acquire first and second OFDM signals, setting first and second initial signal angles, acquiring first and second control signals from the first and second OFDM signals according to the first and second initial signal angles, modulating the intensity and phase of two polarizations perpendicular to each other with the first and second control signals, respectively, to generate first and second optical transmission signals having an intensity-to-phase ratio corresponding to the first and second initial signal angles, and combining the first and second optical transmission signals to transmit the combined optical transmission signals to the first and second optical reception devices.

### CROSS-REFERENCE TO RELATED APPLICATIONS

This application claims priority under 35 U.S.C. § 119 (a) to Korean Patent Application No. 10-2024-0200826, filed on Dec. 30, 2024, with the Korean Intellectual Property Office, the disclosure of which is incorporated herein in its entirety by reference.

### BACKGROUND

### 1. Technical Field

The disclosed embodiments relate to an optical transmission method and device, and more particularly, to an OFDM-NOMA optical transmission method and device utilizing chromatic dispersion.

### 2. Description of the Related Art

In Fiber To The Home (FTTH) networks and mobile fronthauls, optical signals are transmitted through optical channels (or fiber channels). Recently, research has been conducted on a method of transmitting orthogonal frequency division multiplexing (OFDM) signals to two or more reception devices with different transmission distances by overlapping the signals non-orthogonally in frequency according to a non-orthogonal multiple access (NOMA) technique.

In a conventional NOMA system, a transmission device transmits signals by asymmetrically distributing power ratios of the signals to be transmitted. Each reception device then selectively receives signals using a successive interference cancellation (SIC) method, detecting a signal with a highest power first and then sequentially acquiring signals with increasingly lower power. However, this method requires an asymmetric distribution of power ratios of non-orthogonal signals, making it difficult to secure a signal-to-noise ratio (SNR) for non-orthogonal signals with allocated low power. Furthermore, this method is a very limited technique capable of achieving transmission capacity gains only when channels between the transmission device and each reception device are asymmetric. Moreover, all non-orthogonal signal components other than signals required by the reception device act as interference, so that a signal processing technique is required to remove them. Consequently, this method is typically difficult to be used not only in various user devices but also in devices such as base stations and optical network units (ONUs).

### SUMMARY

The purpose of the disclosed embodiments is to provide an optical transmission method and device that enable optical reception devices to easily detect optical signals traveling through optical channels by utilizing a chromatic dispersion phenomenon of the optical signals.

The purpose of the disclosed embodiments is to provide an optical transmission method and device that allow optical signals transmitted in an overlapping manner to be received, with interference therebetween suppressed, by optical reception devices positioned at a distance from each other, thereby enabling each optical reception device to easily detect an optical signal transmitted to itself from the optical signals transmitted in an overlapping manner using only a single photodetector.

According to an aspect of the present disclosure, there is an optical transmission method, including receiving data to be transmitted to first and second optical reception devices to acquire first and second OFDM signals modulated with the same modulation frequency, setting first and second initial signal angles at which first and second optical reception signals received by the first and second optical reception devices, respectively, through an optical channel are power-faded, on the basis of the modulation frequency and transmission distances to the first and second optical reception devices, respectively, acquiring first and second control signals from the first and second OFDM signals according to the first and second initial signal angles, modulating the intensity and phase of two polarizations perpendicular to each other with the first and second control signals, respectively, to generate first and second optical transmission signals having an intensity-to-phase ratio corresponding to the first and second initial signal angles, and combining the first and second optical transmission signals to transmit the combined optical transmission signals to the first and second optical reception devices.

The first initial signal angle among the first and second initial signal angles may be set such that the first optical transmission signal is received by the first optical reception device as a power-faded first optical reception signal, and the second initial signal angle may be set such that the second optical transmission signal is received by the second optical reception device as a power-faded second optical reception signal.

The first and second initial signal angles may be set such that, according to the optical intensity-to-phase magnitude ratio that changes due to a chromatic dispersion effect while the first and second optical transmission signals are transmitted through the optical channel, the optical intensity component is suppressed and received when the signals are received by one of the first and second optical reception devices.

The first and second control signals may be composed of first and second intensity control signals acquired by extracting cosine components according to the first and second initial signal angles from the first and second OFDM signals, and first and second phase control signals acquired by extracting sine components according to the first and second initial signal angles from the first and second OFDM signals.

The first and second optical transmission signals may be generated by performing optical intensity modulation on each of two polarizations applied according to first and second optical intensity modulation control signals generated by adding the first and second intensity control signals and the first and second phase control signals, respectively, performing optical phase modulation on each of two polarizations applied according to first and second optical intensity phase control signals generated by adding the first and second intensity control signals whose signs are inverted and the first and second phase control signals, respectively, and combining an optical intensity-modulated optical signal and an optical phase-modulated optical signal.

The first and second optical transmission signals may be each generated using a dual-drive MZM.

The first and second OFDM signals may be acquired as a plurality of first and second OFDM signals modulated with a plurality of distinct modulation frequencies.

According to another aspect of the present disclosure, there is an optical transmission device, including a memory, and a processor configured to execute at least a part of operations according to a program stored in the memory, in which the processor performs receiving data to be transmitted to first and second optical reception devices to acquire first and second OFDM signals modulated with the same modulation frequency, setting first and second initial signal angles at which the first and second optical reception signals received by the first and second optical reception devices through an optical channel, respectively, are power-faded, on the basis of the modulation frequency and transmission distances to the first and second optical reception devices, respectively, acquiring first and second control signals from the first and second OFDM signals according to the first and second initial signal angles, modulating an optical intensity and a phase of two polarizations perpendicular to each other with first and second control signals, respectively, to generate first and second optical transmission signals having an optical intensity-to-phase magnitude ratio according to the first and second initial signal angles, respectively, and combining the first and second optical transmission signals to transmit the combined optical transmission signals to the first and second optical reception devices.

Therefore, the optical transmission method and device according to the embodiment allow optical signals transmitted in an overlapping manner to be received, with mutual interference therebetween suppressed, by optical reception devices positioned at a distance from each other due to the chromatic dispersion phenomenon that appears while the optical signals pass through optical channels, thereby enabling each optical reception device to easily detect an optical signal transmitted to itself from the optical signals transmitted in an overlapping manner using only a single photodetector.

### BRIEF DESCRIPTION OF THE DRAWINGS

FIG. 1 shows an OFDM-NOMA system model according to one embodiment of the present disclosure.

FIG. 2 is a diagram for describing a chromatic dispersion phenomenon.

FIG. 3 shows an example of a detailed configuration of an optical transmission device of FIG. 1.

FIG. 4 is a diagram for describing operations of a modulation control module and a modulator.

FIG. 5 shows an example of an optical transmission signal optically modulated in a dual-drive MZM under control of the modulation control module.

FIG. 6 shows an example of an optical reception signal received by an optical reception device.

FIG. 7 shows an optical transmission method according to one embodiment of the present disclosure.

FIG. 8 is a diagram for describing a computing environment including a computing device according to one embodiment of the present disclosure.

### DETAILED DESCRIPTION

Hereinafter, specific embodiments of the present disclosure will be described with reference to the drawings. The following detailed description is provided to facilitate a comprehensive understanding of a method, a device, and/or a system described herein. However, this description is provided merely as an example and the present disclosure is not limited thereto.

In describing the embodiments of the present disclosure, detailed descriptions of known technologies related to the present disclosure will be omitted if they are deemed to unnecessarily obscure the gist of the embodiments. Furthermore, terms described below are defined in consideration of functions in the present disclosure and may vary depending on the intent or custom of a user or operator. Therefore, their definitions should be based on an overall content of this specification. Terms used in the detailed description are intended to describe only one embodiment and should not be construed as limiting. Unless expressly stated otherwise, singular forms include plural forms. In this description, expressions such as “include” or “have” are intended to indicate certain characteristics, numbers, steps, operations, elements, parts or combinations thereof, and should not be construed to exclude the presence or possibility of one or more other characteristics, numbers, steps, operations, elements, parts or combinations thereof other than those described. In addition, terms such as “part,” “unit,” “module,” and “block” described in the specification mean a unit that processes at least one function or operation, which may be implemented by hardware, software, or a combination of hardware and software.

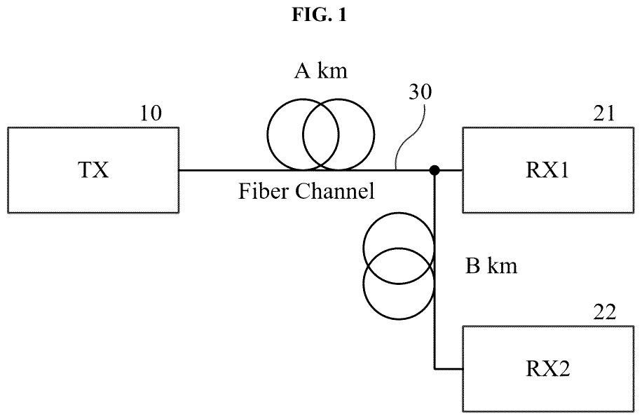

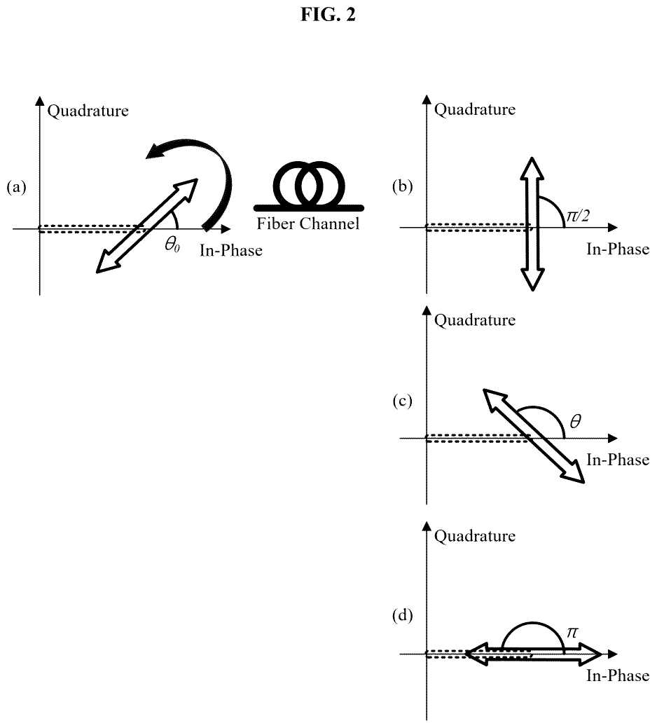

FIG. 1 shows an OFDM-NOMA system model according to one embodiment of the present disclosure, and FIG. 2 is a diagram for describing a chromatic dispersion phenomenon.

Referring to FIG. 1, an OFDM-NOMA system according to one embodiment may include at least one optical transmission device (10) and a plurality of optical reception devices (21 and 22). Here, the optical transmission device (10) may generate an optical transmission signal and transmit it to the plurality of optical reception devices (21 and 22) through an optical channel (30). For convenience of description, it is assumed that two optical reception devices (21 and 22) are disposed, but the number of optical reception devices (21 and 22) may be adjusted in various manners.

Meanwhile, in one embodiment, it is assumed that a first optical reception device (21) is disposed at a distance of A km from the optical transmission device (10), and a second optical reception device (22) is disposed at a distance of B km from the first optical reception device (21). That is, the second optical reception device (22) is disposed at a distance of A+B km from the optical transmission device (10). In FIG. 1, for convenience, the optical channel (30) is shown as being branched and connected to the first and second optical reception devices (21 and 22), but the first and second optical reception devices (21 and 22) may be connected to the optical transmission device (10) through a common optical channel (30). Therefore, the optical transmission signal transmitted from the optical transmission device (10) may be transmitted to not only the first optical reception device (21) but also the second optical reception device (22) through the optical channel (30).

In addition, the optical transmission device (10) generates a modulated optical transmission signal according to an OFDM method and transmits it to the first and second optical reception devices (21 and 22). The optical transmission device (10) may generate an optical transmission signal by intensity modulating and phase modulating an optical carrier.

In FIG. 2, the horizontal axis is an In-Phase (I) axis, which is in-phase with the optical carrier, and represents a magnitude of an intensity component of an optical signal, and the vertical axis is a Quadrature (Q) axis, which is orthogonal to the optical carrier, and represents a magnitude of a phase component of the optical signal. In addition, a yellow line extended in an I-axis direction represents an intensity of the optical carrier, and a red line represents a modulation signal component that is intensity and phase modulated. The optical transmission device (10) may generate an optical transmission signal, as shown in (a) of FIG. 2, by intensity-modulating and phase-modulating an optical carrier and transmit the signal to the optical reception devices (21 and 22) through the optical channel (30).

At this time, the optical transmission signal may have an initial signal angle (00) expressed as a ratio between the magnitude of the intensity and the magnitude of the phase adjusted by the modulation.

Meanwhile, when the optical transmission signal passes through the optical channel (30), a chromatic dispersion phenomenon occurs in which an intensity-modulated component and a phase-modulated component are alternately converted. The chromatic dispersion phenomenon appears in a form where an initial signal angle (00), which is represented by a magnitude ratio between the magnitude and phase of the optical intensity-modulated and phase-modulated modulation signal, is continuously changed while being transmitted through the optical channel (30). This may be viewed as a repetitive process where an optical intensity modulating signal is converted into an optical phase modulating signal while passing through the optical channel (30), and an optical phase modulating signal is converted into an optical intensity modulating signal while passing through the optical channel (30).”

Due to the chromatic dispersion effect, the optical transmission signal transmitted from the optical transmission device (10) continuously changes its signal angle (0) in a process of being transmitted to the optical reception devices (21 and 22) through the optical channel (30). As a result, a signal angle (0) of an optical reception signal received by the optical reception devices (21 and 22) may differ depending on a transmission distance through the optical channel (30), characteristics of the optical channel (30), a wavelength of the optical transmission signal, and a modulation frequency. However, since the characteristics of the optical channel (30) and the wavelength of the optical transmission signal are preset when the optical communication system is configured, the signal angle (0) of the optical reception signal that is an optical transmission signal transmitted from the optical transmission device (10) at the initial signal angle (00) and received by the optical reception devices (21 and 22) through the optical channel (30) may be considered to be determined by a distance and a modulation frequency between the optical transmission device (10) and the optical reception devices (21 and 22).

Accordingly, depending on a distance from the optical transmission device (10) to the optical reception devices (21 and 22), the optical reception signals received by the optical reception devices (21 and 22) have different signal angles (θ) as shown in (b) to (d) of FIG. 2. Here, when the signal angle (θ) of the optical reception signal is received in a Q-axis direction (±½) as shown in (b), the optical reception devices (21 and 22) may only detect a phase modulation component in the Q-axis direction and cannot detect an intensity modulation component in the I-axis direction. However, when the signal angle (θ) is received at an angle between the I-axis and the Q-axis as shown in (c) of FIG. 2, the optical reception devices (21 and 22) may detect both the intensity modulation component in the I-axis direction and the phase modulation component in the Q-axis direction. In addition, when the signal angle (θ) is received in the I-axis direction (0 or π) as shown in (d) of FIG. 2, the optical reception devices (21 and 22) may only detect the intensity modulation component in the I-axis direction and cannot detect the phase modulation component in the Q-axis direction.

The optical reception devices (21 and 22) typically detect a received optical signal using a photodetector capable of detecting the optical intensity, and need to use a plurality of photodetectors to detect the optical phase. Therefore, if a plurality of optical reception devices (21 and 22) are configured with a simple structure each having only one photodetector, the optical reception devices (21 and 22) may only detect a change in intensity of the received optical signal. That is, the optical reception devices (21 and 22) may detect the received optical signal as in (c) and (d) of FIG. 2, but cannot detect the received optical signal as in (b) of FIG. 2. Such a phenomenon is called a power fading phenomenon due to chromatic dispersion, and power fading varies depending on a transmission distance and a modulation frequency. Since the power fading phenomenon is a phenomenon in which power of a specific frequency component is greatly reduced at a specific distance as a result, it generally acts as a deterioration factor occurring in a channel. This power fading phenomenon may be controlled by how the optical transmission device performs optical modulation. In conventional optical communication systems, a method of utilizing frequency bands while excluding a corresponding band where power fading occurs has mainly been used to prevent power fading.

However, the optical transmission device (10) of one embodiment may perform intensity and phase modulation in a frequency band where power fading occurs due to chromatic dispersion, and set the initial signal angle (θ₀) at which power fading occurs at a length of the optical channel (30), i.e., positions of the optical reception devices (21 and 22), thereby controlling that modulated components are not detected in the optical reception signal transmitted to an optical reception device disposed at a specific distance among the plurality of optical reception devices (21 and 22).

Therefore, even if the optical transmission device (10) transmits a plurality of optical transmission signals by overlapping them to the same optical channel (30), at least one of the optical reception devices (21 and 22) receives an optical reception signal whose intensity modulation component is removed due to the power fading phenomenon without separate signal processing.

An optical transmission device (10) of one embodiment utilizes this power fading phenomenon caused by chromatic dispersion to ensure that two or more modulated optical transmission signals are overlapped to be non-orthogonal in frequency and transmitted according to the NOMA technique. In particular, the optical transmission device (10) may set an initial signal angle (θ₁) such that, among the two optical transmission signals that are transmitted in an overlapping manner, a first optical transmission signal has a signal angle (θ=±π/2) at which the intensity modulation component hardly appears and only the phase modulation component appears at a position of the first optical reception device (21) by utilizing the chromatic dispersion phenomenon. In this case, the first optical reception device (21) having a single photodetector may easily detect only a second optical reception signal without performing separate processing. In addition, an initial signal angle (θ₂) may be set such that, at a position of the second optical reception device (22), the second optical reception signal has a signal angle (θ=+π/2) at which the intensity modulation component hardly appears and only the phase modulation component appears. In this case, the second optical reception device (22) may easily detect only the first optical reception signal. That is, the first and second optical reception signals may be transmitted to the first and second optical reception devices (21 and 22) with mutual interference therebetween suppressed.

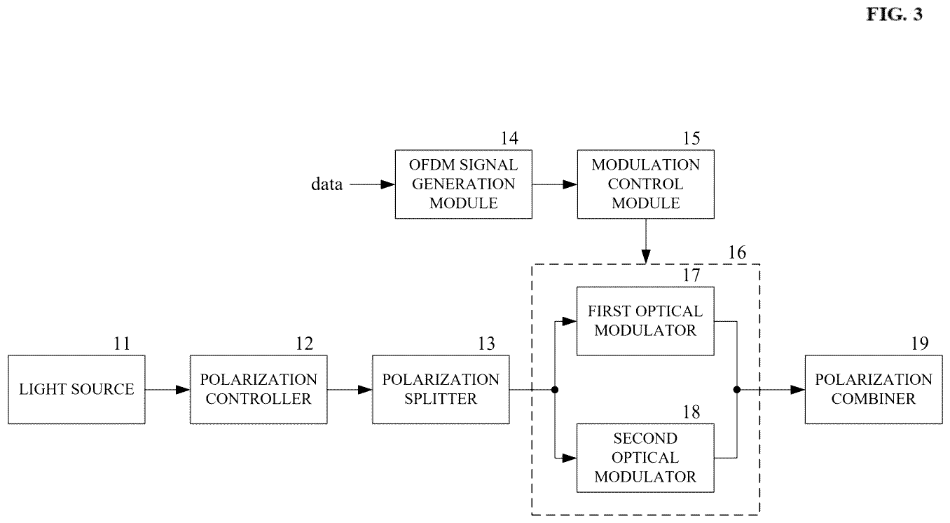

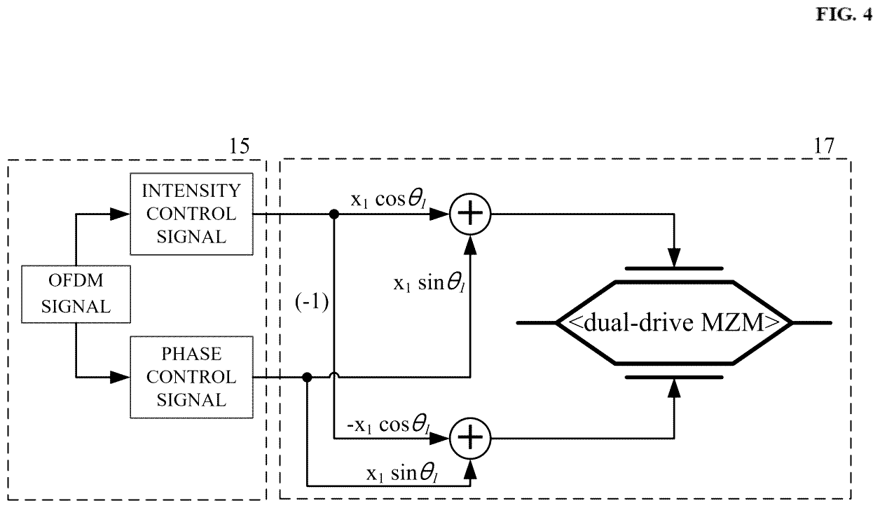

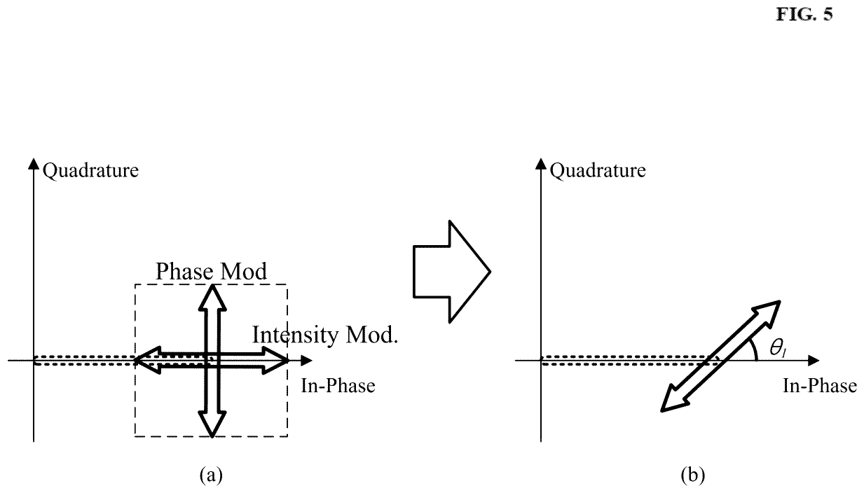

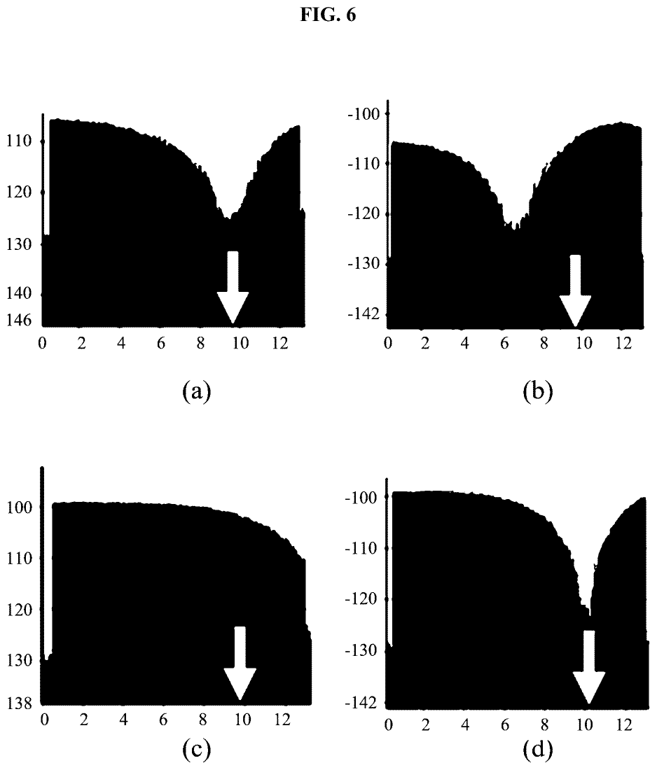

FIG. 3 shows an example of a detailed configuration of the optical transmission device of FIG. 1. FIG. 4 is a diagram for describing operations of a modulation control module and a modulator. FIG. 5 shows an example of an optical transmission signal optically modulated in a dual-drive MZM under control of the modulation control module. FIG. 6 shows an example of the optical reception signal received by the optical reception device.

Referring to FIG. 3, the optical transmission device (10) may include a light source (11), a polarization controller (12), a polarization splitter (13), an OFDM signal generation module (14), a modulation control module (15), an optical modulation module (16), and a polarization combiner (19).

The light source (11) generates and emits light in a continuous wave (CW) mode with a specified wavelength and waveform. The light source (11) may be implemented using a laser diode, and the like. The polarization controller (PC) (12) receives light generated from the light source (11) and converts it into polarized light. The polarization splitter (13) receives the polarized light converted by the polarization controller (12) and splits it into two pieces of polarized light. Polarization directions of the two pieces of separated polarized light may be fixed to be perpendicular (90 degrees) to each other. If the polarization directions of the two pieces of polarization light split by the polarization splitter (13) are not perpendicular to each other, a polarization controller may be additionally disposed to adjust the polarization directions so that they are perpendicular to each other.

The OFDM signal generation module (14) receives a plurality of pieces of data to be transmitted to each of the plurality of optical reception devices (21 and 22). It then generates an OFDM signal for each of the plurality of pieces of received data. For example, the OFDM signal generation module (14) may perform quadrature amplitude modulation (QAM) on the input data to generate digital symbols, serial-to-parallel convert the generated digital symbols and then perform an inverse fast fourier transform (IFFT) to convert the resulting OFDM data into an analog signal, and up-convert it with a modulation frequency (wₘ) to obtain an OFDM signal, which is an RF signal. However, this is merely an example, and the technique for receiving data and generating an OFDM signal is a well-known technique, so that a detailed description will be omitted here.

Here, since it is assumed that the optical transmission device (10) transmits an optical transmission signal to the two optical reception devices (21 and 22), the OFDM signal generation module (14) may receive two pieces of data (d1 and d2) to be transmitted to the two optical reception devices (21 and 22) and generate two OFDM signals (x₁ and x₂). However, when the optical transmission device (10) transmits an optical transmission signal to the two optical reception devices (21 and 22), the OFDM signal generation module (14) may enable each two pieces of data to be up-converted to a signal of the same frequency band among a plurality of modulation frequencies (wₘ) and generated as an OFDM signal. For convenience of description, only two OFDM signals (x₁ and x₂) up-converted with the same modulation frequency (wₘ) will be described as an example hereinafter.

Here, it is assumed that a first OFDM signal (x₁) among two OFDM signals (x₁ and x₂) is power-faded in the first optical reception device (21), and a second OFDM signal (x₂) is a signal that is power-faded in the first optical reception device (21). In other words, it is assumed that the second OFDM signal (x₂) is a signal to be detected in the first optical reception device (21), and the first OFDM signal (x₁) is a signal to be detected in the second optical reception device (22).

The modulation control module (15) receives a plurality of OFDM signals (x₁ and x₂) generated by the OFDM signal generation module (14) and generates control signals for the optical modulation module (16) to perform optical modulation based on the applied OFDM signals. The modulation control module (15) may generate control signals for the first and second OFDM signals (x₁ and x₂), respectively, such that the first OFDM signal (x₁), among the two OFDM signals, is power-faded and not detected in the first optical reception device (21), and the second OFDM signal (x₂) is power-faded and not detected at the second optical reception device (22).

Here, the modulation control module (15) may generate the control signals for the first and second OFDM signals (x₁ and x₂) by dividing them into an intensity control signal and a phase control signal. The modulation control module (15) may preset and store signal angles (θ₁ and θ₂) that cause a power fading phenomenon to occur when an optical signal optically modulated by the optical modulation module (16) is received by the optical reception devices (21 and 22), and may generate an intensity control signal and a phase control signal for each of the OFDM signals (x₁ and x₂) according to the preset signal angles (θ₁ and θ₂).

Referring to FIG. 4, when the first OFDM signal (x₁) is applied, the modulation control module (15) may acquire a cosine component of the applied first OFDM signal (x₁) according to a set signal angle (θ₁) as a intensity control signal (x₁ cos θ₁), while also acquiring a sine component as a phase control signal (x₁ sin θ₁). Similarly, the modulation control module (15) may acquire an intensity control signal (x₂ cos θ₂) and a phase control signal (x₂ sin θ₂) for the second OFDM signal (x₂) in the same manner. In other words, the modulation control module (15) may acquire the intensity control signal (x₁ cos θ₁ and x₂ cos θ₂) and the phase control signals (x₁ sin θ₁ and x₂ sin θ₂) in a form of RF signals according to the OFDM signals (x₁ and x₂).

A specific method for acquiring the signal angle (θ) will be described below.

The optical modulation module (16) receives the polarization split by the polarization splitter (13), and optically modulates and outputs the applied polarization according to the intensity control signals (x₁ cos θ₁ and x₂ cos θ₂) and the phase control signals (x₁ sin θ₁ and x₂ sin θ₂) applied from the modulation control module (15). In one embodiment, the optical modulation module (16) may include first and second optical modulators (17 and 18) that modulate the polarization according to the intensity control signals (x₁ cos θ₁ and x₂ cos θ₂) and the phase control signals (x₁ sin θ₁ and x₂ sin θ₂) for the first and second OFDM signals (x₁ and x₂), respectively. In addition, each of the first and second optical modulators (17 and 18) may be implemented as a dual-drive Mach-Zehnder Modulator (hereinafter, referred to as a dual-drive MZM).

A dual-drive MZM is an optical modulator driven by two RF signals and a DC bias voltage as an input. Typically, the DC bias voltage is applied at half the maximum driving voltage of the dual-drive MZM. Therefore, the dual-drive MZM may perform optical modulation such that the applied polarization has a specified signal angle (θ) depending on magnitudes of the two input RF signals. The two RF signals may be the intensity control signals (x₁ cos θ₁ and x₂ cos θ₂) and the phase control signals (x₁ sin θ₁ and x₂ sin θ₂).

For convenience, FIG. 4 shows only the first optical modulator (17), among the two modulators (17, 18) implemented as a dual-drive MZM. Referring to FIG. 4, the first optical modulator (17) implemented as a dual-drive MZM receives the intensity control signal (x₁ cos θ₁) and the phase control signal (x₁ sin θ₁) for the first OFDM signal (x₁), and performs optical intensity modulation for the applied polarization based on an optical intensity modulation control signal generated by adding (x₁ cos θ₁+x₁ sin θ₁) the applied intensity control signal (x₁ cos θ₁) and the phase control signal (x₁ sin θ₁). In addition, it may also perform optical phase modulation for the applied polarization based on an optical phase modulation control signal generated by adding (−x₁ cos θ₁+x₁ sin θ₁) an intensity control signal (−x₁ cos θ₁) whose sign is inverted and the phase control signal (x₁ sin θ₁).

In FIG. 5, the horizontal axis represents an intensity modulation component of an optical signal along the In-Phase (I) axis, which is in-phase with the applied polarization. The vertical axis represents a phase modulation component of the optical signal along the Quadrature (Q) axis, which is orthogonal to the polarization. A yellow line extending in the I-axis direction represents an intensity of the polarization, and a red line represents modulated signal components, which are intensity and phase modulated.

As shown in (a) of FIG. 5, the dual-drive MZM performs optical intensity modulation on the applied polarization according to the intensity control signal (x₁ cos θ₁) and the phase control signal (x₁ sin θ₁) to adjust the intensity in the I-axis direction, and performs optical phase modulation thereon to adjust the phase in the Q-axis direction. Then, by combining the intensity-modulated polarization and the phase-modulated polarization, a first optical transmission signal having a specified initial signal angle (θ₁) may be generated to be intensity and phase modulated, as shown in (b) of FIG. 5.

A polarization combiner (19) receives first and second optical transmission signals optically modulated by the first and second optical modulators (17 and 18) of the optical modulation module (16), respectively, combines the applied first and second optical transmission signals, and acquires an optical transmission signal in which the first and second optical transmission signals are overlapped. Then, the acquired optical transmission signal is transmitted to the optical reception devices (21 and 22) through an optical channel (30).

Here, the signal angles (θ₁ and θ₂) that cause the optical signal to be received with an occurrence of the power fading phenomenon by the first and second optical reception devices (21 and 22) may be calculated and set based on a center wavelength (20) of the modulated optical signal, a modulation frequency (wₘ) of the OFDM signal, and a transmission distance (L1=A km, L2=A+B km).

The chromatic dispersion that occurs in a process of transmission of an optical signal through an optical channel is expressed by a function H (w) in Equation 1.

$$H ( w ) = exp ( j \frac{D {λ}_{0}^{2} L}{4 π c} {w}_{m}^{2} ) \qquad [ Math 1 ]$$

(Here, λ₀ represents a center wavelength of an optical signal, wₘ represents a modulation frequency of an OFDM signal, D represents a chromatic dispersion parameter, L represents a transmission distance, and c represents a speed of light.)

In Equation 1, until an optical signal transmitted through an optical channel reaches an optical reception device positioned at a transmission distance (L), a signal angle (θ) of the optical signal rotated due to chromatic dispersion may be calculated using Equation 2.

$$θ = \frac{D {λ}_{0}^{2} L}{4 π c} {w}_{m}^{2} \qquad [ Math 2 ]$$

In order for a modulated optical transmission signal in the optical transmission device (10) to be power-faded in the optical reception device, an optical reception signal received by the optical reception device needs to include only the optical intensity and phase modulation components. In other words, a signal angle of the optical reception signal must be (π/2). Therefore, in order for the optical transmission signal transmitted from the optical transmission device (10) to be received as a power-faded optical reception signal by the optical reception device positioned at the transmission distance (L), the optical transmission signal needs to have an initial signal angle (θ₀ rad) according to Equation 3.

$${θ}_{0} = \frac{D {λ}_{0}^{2} L}{4 π c} {w}_{m}^{2} + \frac{π}{2} \qquad [ Math 3 ]$$

Here, it is assumed that the first and second optical reception devices (21 and 22) are positioned at a distance of A km and a distance of A+B km, respectively, from the optical transmission device (10), so that initial signal angles (θ₁ and θ₂) of each of the first and second optical transmission signals to be power-faded may be set according to Equations 4 and 5.

$${θ}_{1} = \frac{D {λ}_{0}^{2} A \times {10}^{3}}{4 π c} {w}_{m}^{2} + \frac{π}{2} \qquad [ Math 4 ]$$

$${θ}_{2} = \frac{D {λ}_{0}^{2} ( A + B ) \times {10}^{3}}{4 π c} {w}_{m}^{2} + \frac{π}{2} \qquad [ Math 5 ]$$

Here, 10³ is a value to be added when converting km into m.

In FIG. 6, (a) and (b) represent first optical transmission signals received by the first and second optical reception devices (21 and 22), while (c) and (d) of FIG. 6 represent second optical transmission signals received by the first and second optical reception devices (21 and 22). In FIG. 6, the horizontal axis represents a frequency, and the vertical axis represents an intensity (dB) of the optical reception signal.

Looking at (a) and (b) of FIG. 6, it is known that when the first optical transmission signal is received by the first optical reception device (21) at a distance of A km, its intensity is significantly reduced due to power fading in a 10 GHz frequency band, which is a modulation frequency (wₘ) of the OFDM signal. On the other hand, when it is received by the second optical reception device (22) at a distance of A+B km, its intensity appears very high in the same frequency band. Furthermore, looking at (c) and (d) of FIG. 6, it is known that when the second optical transmission signal is received by the first optical reception device (21) at the distance of A km, its intensity appears very high in the 10 GHz frequency band, while, when it is received by the second optical reception device (22) at the distance of A+B km, its intensity is significantly reduced due to power fading in the same frequency band.

Therefore, the first and second optical reception devices (21 and 22) may effectively detect one of two optical transmission signals transmitted in an overlapping manner using a single photodetector without performing additional signal processing.

Here, although the first and second OFDM signals are modulated signals with the same modulation frequency (wₘ), they may be transmitted independently without mutual interference, enabling non-orthogonal transmission using the NOMA technique.

Furthermore, the OFDM signal generation module (14) performs modulation with a plurality of distinct modulation frequencies (wₘ) on OFDM signals with different modulation frequencies (wₘ) such that the non-orthogonal transmission according to the NOMA technique is made to perform orthogonal transmission, thereby achieving twice the transmission efficiency compared to conventional OFDM transmission techniques.

In the shown embodiment, constituents may have different functions and capabilities in addition to those described above, and additional constituents not described herein may also be included. Additionally, in one embodiment, each configuration may be implemented using one or more physically distinct devices, or may be implemented by one or more processors, or a combination of one or more processors and software, and may not be clearly distinguished in its specific operation, unlike shown examples.

The optical transmission device shown in FIG. 3 may be implemented within a logic circuit using hardware, firmware, software, or a combination thereof, or may be implemented using a general-purpose or special-purpose computer. The device may be implemented using a hardwired device, a field programmable gate array (FPGA), an application-specific integrated circuit (ASIC), or the like. Moreover, the device may be implemented as a system-on-chip (SoC) including one or more processors and controllers.

Furthermore, the optical transmission device may be mounted on a computing device or server equipped with hardware elements in a form of software, hardware, or a combination thereof. A computing device or server may refer to various devices, including, in whole or in part, a communication device such as a communication modem for communicating with various devices or wired or wireless communication networks, a memory for storing data for executing programs, and a microprocessor for executing programs to perform operations and commands.

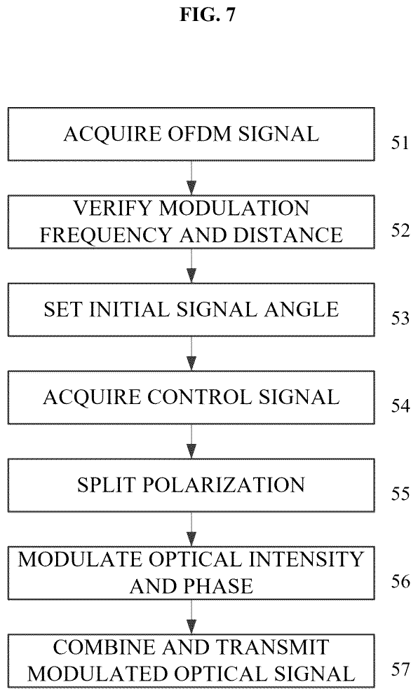

FIG. 7 shows an optical transmission method according to one embodiment.

Referring to FIG. 7, in an optical transmission method of one embodiment, data (d1, d2) to be transmitted to the plurality of optical reception devices (21 and 22) are received first, and they are modulated with a signal at a modulation frequency (wₘ), to acquire first and second OFDM signals (x₁ and x₂) (51). Then, the modulation frequency (wₘ) and the distances (A, A+B) to the first and second optical reception devices (21 and 22) are verified (52).

Once the modulation frequency (wₘ) and the distances (L₁ and L₂) to the first and second optical reception devices (21 and 22) are verified, first and second initial signal angles (θ₁ and θ₂) are set according to Equations 4 and 5 based on the verified modulation frequency (wₘ) and the distances (A, A+B) to the first and second optical reception devices (21 and 22) (53). When the first and second initial signal angles (θ₁ and θ₂) are set, first and second intensity control signals (x₁ cos θ₁, x₂ cos θ₂) and first and second phase control signals (x₁ sin θ₁, x₂ sin θ₂) are acquired from the first and second OFDM signals (x₁ and x₂) according to the set initial signal angles (θ₁ and θ₂) (54).

Meanwhile, light generated from a light source is split into two polarizations that are perpendicular to each other (55). Then, each of the two split polarizations is subjected to light intensity and phase modulation according to the first and second intensity control signals (x₁ cos θ₁, x₂ cos θ₂) and the first and second phase control signals (x₁ sin θ₁, x₂ sin θ₂) to generate first and second optical transmission signals having the first and second initial signal angles (θ₁ and θ₂), respectively (56). At this time, the first optical modulator (17) implemented as a dual-drive MZM generates a first optical transmission signal having an optical intensity-to-phase magnitude ratio corresponding to a first initial signal angle (θ₁) based on a first intensity control signal (x₁ cos θ₁) and a first phase control signal (x₁ sin θ₁), and the second optical modulator (18) generates a second optical transmission signal having an optical intensity-to-phase magnitude ratio corresponding to a second initial signal angle (θ₂) based on a second intensity control signal (x₂ cos θ₂) and a second phase control signal (x₂ sin θ₂).

Then, the generated first and second optical transmission signals are combined and transmitted to the first and second optical reception devices (21 and 22) through an optical channel.

Although FIG. 7 describes that each process is executed sequentially, this is merely an example, and those skilled in the art can apply various modifications and transformations, such as changing the order described in FIG. 7 to execute it, executing one or more processes in parallel, or adding other processes, within a range not departing from the essential characteristics of the embodiments of the present disclosure.

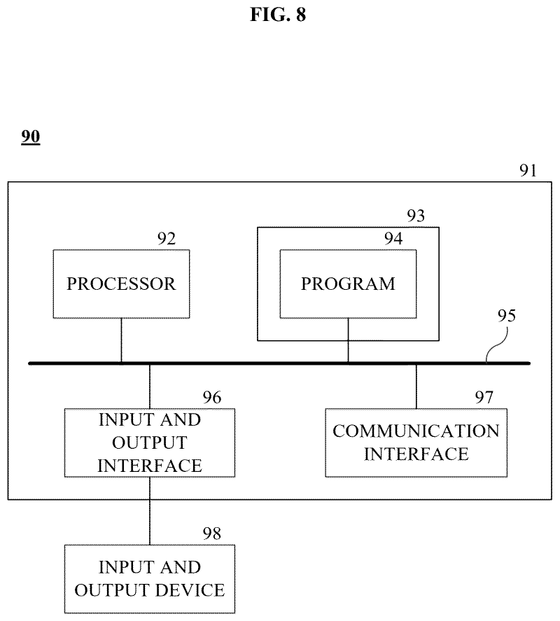

FIG. 8 is a diagram for describing a computing environment including a computing device according to one embodiment.

In the shown embodiment, each component may have different functions and capabilities in addition to those described below, and may include additional components in addition to those described below. The shown computing environment (90) includes a computing device (91) and may perform the optical transmission method shown in FIG. 7. In one embodiment, the computing device (91) may be one or more components included in the optical transmission device shown in FIG. 3.

The computing device (91) includes at least one processor (92), a computer-readable storage medium (93), and a communication bus (95). The processor (92) may cause the computing device (91) to operate according to the exemplary embodiments described above. For example, the processor (92) may execute one or more programs (94) stored on the computer-readable storage medium (93). The one or more programs (94) may include one or more computer-executable instructions, which, when executed by the processor (92), may be configured to cause the computing device (91) to perform operations according to the exemplary embodiment.

The communication bus (95) interconnects various other components of the computing device (91), including the processor (92) and the computer-readable storage medium (93).

The computing device (91) may also include one or more input and output interfaces (96) and one or more communication interfaces (97) that provide interfaces for one or more input and output devices (98). The input and output interfaces (96) and the communication interfaces (97) are connected to a communication bus (95). The input and output devices (98) may be connected to other components of the computing device (91) via the input and output interfaces (96). The exemplary input and output devices (98) may include input devices such as pointing devices (such as a mouse or a trackpad), a keyboard, touch input devices (such as a touchpad or a touchscreen), voice or sound input devices, various types of sensor devices and/or photographing devices, and/or output devices such as display devices, printers, speakers and/or network cards. The exemplary input and output devices (98) may be included within the computing device (91) as a component constituting the computing device (91), or may be connected to the computing device (91) as a separate device distinct from the computing device (91).

While the present disclosure has been described in detail above through representative examples, those skilled in the art will appreciate that various modifications and equivalent embodiments are possible. Therefore, the true scope of technical protection of the present disclosure should be determined by the technical spirit of the appended claims.

What is claimed is:

1. An optical transmission method comprising:
receiving data to be transmitted to first and second optical reception devices to acquire first and second orthogonal frequency division multiplexing (OFDM) signals modulated with the same modulation frequency;
setting first initial signal angle and second initial signal angle at which first and second optical reception signals received by the first and second optical reception devices, respectively, through an optical channel are power-faded, on the basis of a modulation frequency and transmission distances to the first and second optical reception devices, respectively;
acquiring first and second control signals from the first and second OFDM signals according to the first and second initial signal angles;
modulating an intensity and a phase of two polarizations perpendicular to each other with the first and second control signals, respectively, to generate first and second optical transmission signals having an intensity-to-phase ratio corresponding to the first and second initial signal angles; and
combining the first and second optical transmission signals to transmit the combined optical transmission signals to the first and second optical reception devices.

2. The optical transmission method according to claim 1,
wherein the first initial signal angle among the first and second initial signal angles is set such that the first optical transmission signal is received by the first optical reception device as a power-faded first optical reception signal, and
the second initial signal angle is set such that the second optical transmission signal is received by the second optical reception device as a power-faded second optical reception signal.

3. The optical transmission method according to claim 1,
wherein the first and second initial signal angles are set such that, according to an intensity-to-phase ratio that changes due to a chromatic dispersion effect while the first and second optical transmission signals are transmitted through the optical channel, an optical intensity component is suppressed and received when the first and second optical transmission signals are received by one of the first and second optical reception devices.

4. The optical transmission method according to claim 1,
wherein the first and second initial signal angles are each set according to Equation
$${θ}_{0} = \frac{D {λ}_{0}^{2} L}{4 π c} {w}_{m}^{2} + \frac{π}{2}$$
(where θ₀ is an initial signal angle, λ₀ is a center wavelength of an optical signal, wₘ is a modulation frequency, D is a chromatic dispersion parameter, L is an optical channel transmission distance, and c is a speed of light).

5. The optical transmission method according to claim 1,
wherein the first and second control signals are composed of first and second intensity control signals acquired by extracting cosine components according to the first and second initial signal angles from the first and second OFDM signals, and
first and second phase control signals acquired by extracting sine components according to the first and second initial signal angles from the first and second OFDM signals.

6. The optical transmission method according to claim 5,
wherein the first and second optical transmission signals are generated by performing optical intensity modulation on each of two polarizations applied according to first and second optical intensity modulation control signals generated by adding the first and second intensity control signals and the first and second phase control signals, respectively,
performing optical phase modulation on each of two polarizations applied according to first and second optical intensity phase control signals generated by adding the first and second intensity control signals whose signs are inverted and the first and second phase control signals, respectively, and
combining an optical intensity-modulated optical signal and an optical phase-modulated optical signal.

7. The optical transmission method according to claim 1,
wherein the first and second optical transmission signals are each generated using a dual-drive MZM.

8. The optical transmission method according to claim 1,
wherein the first and second OFDM signals are acquired as a plurality of first and second OFDM signals modulated with a plurality of distinct modulation frequencies.

9. The optical transmission method according to claim 1,
wherein the optical transmission method is performed by a processor of a device including a memory and a processor.

10. An optical transmission device comprising:
a memory; and
a processor configured to execute at least a part of operations according to a program stored in the memory,
wherein the processor performs:
receiving data to be transmitted to first and second optical reception devices to acquire first and second orthogonal frequency division multiplexing (OFDM) signals modulated with the same modulation frequency,
setting first initial signal angle and second initial signal angle at which first and second optical reception signals received by the first and second optical reception devices through an optical channel, respectively, are power-faded, on the basis of a modulation frequency and transmission distances to the first and second optical reception devices, respectively;
acquiring first and second control signals from the first and second OFDM signals according to the first and second initial signal angles;
modulating an optical intensity and a phase of two polarizations perpendicular to each other with first and second control signals, respectively, to generate first and second optical transmission signals having an optical intensity-to-phase magnitude ratio according to the first and second initial signal angles, respectively; and
combining the first and second optical transmission signals to transmit the combined optical transmission signals to the first and second optical reception devices.

11. The optical transmission device according to claim 10,
wherein the first initial signal angle among the first and second initial signal angles is set such that the first optical transmission signal is received as a first optical reception signal power-faded by the first optical reception device, and
the second initial signal angle is set such that the second optical transmission signal is received as a second optical reception signal power-faded by the second optical reception device.

12. The optical transmission device according to claim 10,
wherein the first and second initial signal angles are set such that, according to the optical intensity-to-phase magnitude ratio that changes due to a chromatic dispersion effect while the first and second optical transmission signals are transmitted through the optical channel, an optical intensity component is suppressed and received when the first and second optical transmission signals are received by one of the first and second optical reception devices.

13. The optical transmission device according to claim 10, wherein the first and second initial signal angles are each set according to Equation
$${θ}_{0} = \frac{D {λ}_{0}^{2} L}{4 π c} {w}_{m}^{2} + \frac{π}{2}$$
(where θ₀ is an initial signal angle, λ₀ is a center wavelength of an optical signal, wₘ is a modulation frequency, D is a chromatic dispersion parameter, L is an optical channel transmission distance, and c is a speed of light).

14. The optical transmission device according to claim 10,
wherein the first and second control signals are composed of first and second intensity control signals acquired by extracting cosine components according to the first and second initial signal angles from the first and second OFDM signals, and
first and second phase control signals acquired by extracting sine components according to the first and second initial signal angles from the first and second OFDM signals.

15. The optical transmission device according to claim 14,
wherein the first and second optical transmission signals are generated by performing optical intensity modulation on each of the two polarizations applied according to first and second optical intensity modulation control signals generated by adding the first and second intensity control signals and the first and second phase control signals, respectively,
performing optical phase modulation on the two polarizations applied according to first and second optical intensity phase control signals generated by adding the first and second intensity control signals whose signs are inverted and the first and second phase control signals, respectively; and
combining an optical intensity-modulated optical signal and an optical phase-modulated optical signal.

16. The optical transmission device according to claim 10,
wherein the first and second optical transmission signals are generated by controlling two dual-drive MZMs, each receiving the two polarizations, with the first and second control signals.

17. The optical transmission device according to claim 10,
wherein the first and second OFDM signals are acquired as a plurality of first and second OFDM signals modulated with a plurality of distinct modulation frequencies.
